(19) United States
(12) Patent Application Publication
(10) Pub. No.: US 2025/0335779 A1
(43) Pub. Date: Oct. 30, 2025

(54) MODEL POISONING DETECTION FOR ARTIFICIAL INTELLIGENCE MODELS

(71) Applicant: LENOVO (SINGAPORE) PTE. LTD, SINGAPORE (SG)

(72) Inventors: Souvik Paul, Bad Homburg (DE); Sheeba Backia Mary Baskaran, Friedrichsdorf (DE)

(73) Assignee: LENOVO (SINGAPORE) PTE. LTD, SINGAPORE (SG)

(21) Appl. No.: 18/647,885

(22) Filed: Apr. 26, 2024

(51) Int. Cl. G06N 3/094; G06N 3/045

(52) U.S. Cl. CPC G06N 3/094; G06N 3/045

(57) ABSTRACT

Various aspects of the present disclosure relate to model poisoning detection for artificial intelligence models. An apparatus, such as a network equipment (NE), generates a first distance value based at least in part on a comparison of one or more first artificial intelligence models and one or more second artificial intelligence models. The NE compares the first distance value to a distance value threshold and generates a flag to initiate poisoning score detection based at least in part on whether the first distance value surpasses the distance value threshold. The NE generates one or more model poisoning scores based at least in part on comparison of the first artificial intelligence model and one or more third artificial intelligent models in training.

### TECHNICAL FIELD

The present disclosure relates to wireless communications, and more specifically to artificial intelligence in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a first network equipment (NE) for wireless communication to generate a first distance value based at least in part on a comparison of one or more first artificial intelligence models and one or more second artificial intelligence models; compare the first distance value to a distance value threshold; generate a flag to initiate poisoning score detection based at least in part on whether the first distance value exceeds the distance value threshold; and generate one or more model poisoning scores based at least in part on comparison of the first artificial intelligence model and one or more third artificial intelligent models in training.

In some implementations of the method and apparatuses for a first NE described herein, the one or more first artificial intelligence models include one or more previously trained artificial intelligence models, the one or more second artificial intelligence models include one or more currently aggregated artificial intelligence models, and the one or more of third artificial intelligence models include one or more artificial intelligence models currently in training; to generate the first distance value, at least one processor is configured to cause the first NE to: generate a first feature representation of the one or more first artificial intelligence models, and a second feature representation of the one or more second artificial intelligence models; and generate the first distance value based at least in part on a distance between the first feature representation and the second feature representation; to generate the first distance value, the at least one processor is configured to cause the first NE to: generate a first description of the one or more first artificial intelligence models, the first description including one or more of an image-based description or a text-based description of the one or more first artificial intelligence models; generate a second description of the one or more second artificial intelligence models, the second description including one or more of an image-based description or a text-based description of the one or more second artificial intelligence models; and generate the first distance value based at least in part on a distance between the first description including one or more of the image-based description or the text-based description of the one or more first artificial intelligence models and the second description including the one or more of an image-based description or a text-based description of the one or more second artificial intelligence models; the model poisoning score includes one or more of a numerical value or a percentage likelihood value that the one or more third artificial intelligence models are in a poisoned state.

In some implementations of the method and apparatuses for a first NE described herein, the one or more third artificial intelligence models include one or more classes of artificial intelligence models, and wherein at least one processor is configured to cause the first NE to generate a targeting indication including an indication of whether poisoning of the one or more third artificial intelligence models is targeted to at least one class of the one or more classes of artificial intelligence models; the at least one processor is configured to cause the first NE to transmit one or more of the model poisoning score, a client identifier, or a model identifier to a second NE; the first NE includes an artificial intelligence network function and the second NE includes a server network data analytics function (NWDAF); determine that the first distance value exceeds the distance value threshold; receive, from one or more client NWDAFs and based at least in part on the first distance value exceeding the distance value threshold, one or more third artificial intelligence models; generate a second distance value based at least in part on a comparison of the one or more first artificial intelligence models and one or more third artificial intelligence models; and generate the flag to initiate the poisoning score detection further based at least in part on whether the second distance value exceeds the distance value threshold; the model poisoning score includes a likelihood that poisoning of the one or more third artificial intelligence models occurred via the one or more client NWDAFs; the first NE includes a server NWDAF; receive, from a second NE, a subscription request for poisoning detection for the one or more third artificial intelligence models; and transmit, to the second NE, a poisoning detection result including the model poisoning score; receive, from the second NE, one or more identifiers for one or more third NE that participated in training the one or more third artificial intelligence models; and assign the model poisoning score to at least one of the one or more third NE.

Some implementations of the method and apparatuses described herein may further include a second NE for wireless communication to transmit, to a first NE, a subscription request for poisoning detection for one or more third artificial intelligence models; and receive, from the first NE, a poisoning detection result including a model poisoning score indicating a likelihood that at least one of the one or more third artificial intelligence models (e.g., identified with one or more machine learning (ML) model(s) identifier(s)) is in a poisoned state.

In some implementations of the method and apparatuses for a second NE described herein, the poisoning detection result includes an indication that at least one of the one or more third artificial intelligence models is likely in a poisoned state, and a targeting indication including an indication of whether poisoning of the at least one of the one or more third artificial intelligence models is targeted to at least one class of one or more classes of artificial intelligence models; at least one processor is configured to cause the second NE to transmit, to the first NE, one or more identifiers for one or more third NE that participated in training of the one or more second artificial intelligence models, wherein the poisoning detection result is associated with at least one of the one or more third NE; the at least one processor is configured to cause the second NE to: select one or more candidate artificial intelligence models from the one or more third artificial intelligence models based at least in part on the poisoning detection result indicating that the one or more candidate artificial intelligence models are likely not in a poisoned state; and utilize the one or more candidate artificial intelligence models for one or more of model training or data inference; the at least one processor is configured to cause the second NE to: determine, based at least in part on the poisoning detection result, that the one or more third artificial intelligence models are likely in a poisoned state; discard the one or more second artificial intelligence models; and exclude one or more poisoned clients associated with the one or more third artificial intelligence models likely in a poisoned state from taking part in one or more next rounds of FL model training.

Some implementations of the method and apparatuses described herein may further include a method performed by a first NE, the method including generating a first distance value based at least in part on a comparison of one or more first artificial intelligence models and one or more second artificial intelligence models; comparing the first distance value to a distance value threshold; generating a flag to initiate poisoning score detection based at least in part on whether the first distance value exceeds the distance value threshold; and generating one or more model poisoning scores based at least in part on comparison of the first artificial intelligence model and one or more third artificial intelligent models in training.

In some implementations of the method and apparatuses for a first NE described herein, the one or more first artificial intelligence models include one or more previously trained artificial intelligence models, the one or more second artificial intelligence models include one or more currently aggregated artificial intelligence models, and the one or more of third artificial intelligence models include one or more artificial intelligence models currently in training; generating the first distance value includes: generating a first feature representation of the one or more first artificial intelligence models, and a second feature representation of the one or more second artificial intelligence models; and generating the first distance value based at least in part on a distance between the first feature representation and the second feature representation; generating the first distance value includes: generating a first description of the one or more first artificial intelligence models, the first description including one or more of an image-based description or a text-based description of the one or more first artificial intelligence models; generating a second description of the one or more second artificial intelligence models, the second description including one or more of an image-based description or a text-based description of the one or more second artificial intelligence models; and generating the first distance value based at least in part on a distance between the first description including one or more of the image-based description or the text-based description of the one or more first artificial intelligence models and the second description including the one or more of an image-based description or a text-based description of the one or more second artificial intelligence models; the model poisoning score includes one or more of a numerical value or a percentage likelihood value that the one or more third artificial intelligence models are in a poisoned state.

In some implementations of the method and apparatuses for a first NE described herein, the one or more third artificial intelligence models include one or more classes of artificial intelligence models, and wherein the method further includes generating a targeting indication including an indication of whether poisoning of the one or more third artificial intelligence models is targeted to at least one class of the one or more classes of artificial intelligence models; further including transmitting one or more of the model poisoning score, a client identifier, or a model identifier to a second NE; the first NE includes an artificial intelligence network function and the second NE includes a server NWDAF; further including: determining that the first distance value exceeds the distance value threshold; receiving, from one or more client NWDAFs and based at least in part on the first distance value exceeding the distance value threshold, the one or more third artificial intelligence models; generating a second distance value based at least in part on a comparison of the one or more first artificial intelligence models and the one or more third artificial intelligence models; and generating the flag to initiate the poisoning score detection further based at least in part on whether the second distance value exceeds the distance value threshold; the model poisoning score includes a likelihood that poisoning of the one or more third artificial intelligence models occurred via the one or more client NWDAFs; the first NE includes a server NWDAF; further including: receiving, from a second NE, a subscription request for poisoning detection for the one or more third artificial intelligence models; and transmitting, to the second NE, a poisoning detection result including the model poisoning score; further including: receiving, from the second NE, one or more identifiers for one or more third NE that participated in training the one or more third artificial intelligence models; and assigning the model poisoning score to at least one of the one or more third NE.

Some implementations of the method and apparatuses described herein may further include a method performed by a second NE, the method including transmitting, to a first NE, a subscription request for poisoning detection for one or more third artificial intelligence models; and receiving, from the first NE, a poisoning detection result including a model poisoning score indicating a likelihood that at least one of the one or more third artificial intelligence models (e.g., identified with one or more ML model(s) identifier(s)) is in a poisoned state.

In some implementations of the method and apparatuses described herein, the poisoning detection result includes an indication that at least one of the one or more third artificial intelligence models is likely in a poisoned state, and a targeting indication including an indication of whether poisoning of the at least one of the one or more third artificial intelligence models is targeted to at least one class of one or more classes of artificial intelligence models; further including transmitting, to the first NE, one or more identifiers for one or more third NE that participated in training of the one or more second artificial intelligence models, wherein the poisoning detection result is associated with at least one of the one or more third NE; selecting one or more candidate artificial intelligence models from the one or more third artificial intelligence models based at least in part on the poisoning detection result indicating that the one or more candidate artificial intelligence models are likely not in a poisoned state; and utilizing the one or more candidate artificial intelligence models for one or more of model training or data inference; determining, based at least in part on the poisoning detection result, that the one or more third artificial intelligence models are likely in a poisoned state; discarding the one or more second artificial intelligence models; and excluding one or more poisoned clients associated with the one or more third artificial intelligence models likely in a poisoned state from taking part in one or more next rounds of FL model training.

### BRIEF DESCRIPTION OF THE DRAWINGS

FIG. 1 illustrates an example of a wireless communications system in accordance with aspects of the present disclosure.

FIG. 2 illustrates an example architecture 200 for trained ML model provisioning.

FIGS. 3-5 illustrate an example procedure 300 for model poisoning detection in accordance with aspects of the present disclosure.

FIGS. 6-8 illustrate an example procedure 600 for model poisoning detection in accordance with aspects of the present disclosure.

FIG. 9 illustrates an example of a NE 900 in accordance with aspects of the present disclosure.

FIG. 10 illustrates a flowchart of a method 1000 in accordance with aspects of the present disclosure.

FIG. 11 illustrates a flowchart of a method 1100 in accordance with aspects of the present disclosure.

### DETAILED DESCRIPTION

Wireless communications systems can utilize artificial intelligence (AI) and ML for a variety of different purposes, such as for network optimization, automated processing (e.g., self-driving cars in vehicle to everything (V2X) scenarios), network planning, security information and event management (SIEM)), etc. AI/ML in wireless communications systems can involve processes such as model training, model testing, and inference. Training of AI/ML models can be data dependent and control of AI/ML data can present challenges to involved parties. For instance, AI/ML models can be poisoned during a training phase, such as by injecting false data into training data (data poisoning attacks) and/or AI/ML models can be manipulated by potential attackers in an AI/ML system (model poisoning attack).

As opposed to some AI/ML implementations where data can be inspected (which may not be favorable due to privacy issues and general data protection regulation (GDPR) regulations), in federated learning (FL) data involved in model training may remain private. In such scenarios inspection of AI/ML models can be important, such as to detect potential model poisoning and to attempt to determine an intention of potential attackers. Thus, in FL AI/ML scenarios (e.g., where model training takes places privately at individual clients and models are aggregated at the server), a number of challenges can result. For instance, in FL, client-side data with which models are trained locally may not be accessible to the server and can be susceptible to poisoning attacks from malicious clients. Further, for large language models and similar scenarios, AI/ML models can include billions of parameters which are computationally expensive to analyze by clustering or similar methods for detecting poisoning attacks.

Accordingly, aspects of the present disclosure present solutions for detecting AI/ML model poisoning (e.g., in a FL system) that mitigate resource usage and data privacy leakage for clients involved in AI/ML model training. For instance, explainable AI (XAI) can be leveraged in such scenarios (e.g., FL scenarios) to determine where and what type of poisoning attacks are taking place to defend against such poisoning attached. Examples of defenses against poisoning attacks can include discarding poisoned AI/ML models, identifying a location of an attacker, identifying a client involved in a data poisoning attack, etc. XAI, for example, refers to a set of processes and methods that enable human users to comprehend and determine trust status of results produced by AI/ML models.

More specifically, solutions described in the present disclosure provide for identification of poisoning attacks and poisonous nodes (e.g., in FL scenarios) where AI/ML poisoning originates from client nodes, e.g., client NWDAFs in scenarios involving FL training using multiple NWDAFs. AI/ML model poisoning that occurs during model training, for instance, can be performed utilizing one or more of a cutoff thresholding, XAI model feature importance, and assignment of poisoning scores to client nodes and/or AI/ML models.

In implementations, to reduce the time complexity of procedures for identification of poisoning in clients, an initial difference in the form of distance metric and/or statistical estimation is calculated between a global model (e.g., a previously trained model) and a new aggregated model to determine if the difference is within a threshold. If the threshold is exceeded, a client model and/or a subset of client models (e.g., where the accuracy of the global model is at convergence with a threshold number of training rounds and a threshold number of client NWDAFs are trusted by the server to have a trusted model) performs explanation (e.g., model feature importance and/or true model label(s)) of the client model and/or subset of client models on an evenly distributed dataset. A difference of the explanation is then measured (e.g., using Euclidean distance and/or other distance metric) of the client models with the global model from a previous global round of training. A likelihood of model poisoning (e.g., a numeric value and/or percentage value) and model poisoning detection result (e.g., poisoned/not poisoned, targeted/non-targeted) can be assigned if model poisoning is determined to occur at the client nodes based on the distance metrics of statistical estimation calculated from the client nodes' local models and the global model.

By utilizing the described techniques, AI/ML techniques can be utilized while mitigating and/or preventing the effects of potential AI/ML model poisoning, e.g., AI/ML model corruption that can lead to erroneous model training and model inference.

Aspects of the present disclosure are described in the context of a wireless communications system.

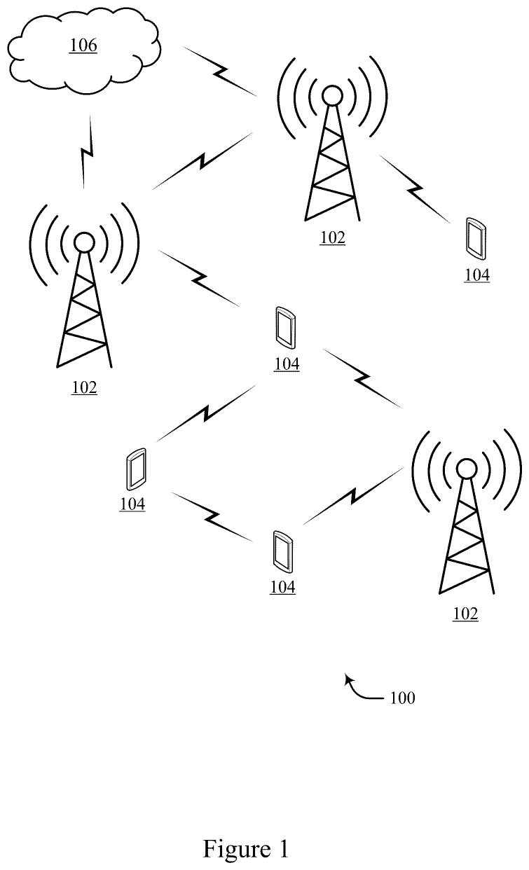

FIG. 1 illustrates an example of a wireless communications system 100 in accordance with aspects of the present disclosure. The wireless communications system 100 may include one or NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (e.g., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologics (e.g., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 are operable to implement various aspects of the techniques described with reference to the present disclosure. For example, a NE 102 (e.g., an explainable AI function (XAIF) and/or a server NWDAF) can generate a first distance value based at least in part on a comparison of one or more first artificial intelligence models and one or more second artificial intelligence models; compare the first distance value to a distance value threshold; generate a flag to initiate poisoning score detection based at least in part on whether the first distance value exceeds the distance value threshold; and generate one or more model poisoning scores based at least in part on comparison of the first artificial intelligence model and one or more third artificial intelligent models in training. In implementations where model poisoning detection is performed at an XAIF, a second NE 102 (e.g., server NWDAF) can transmit, to a first NE 102 (e.g., an XAIF), a subscription request for poisoning detection for one or more second artificial intelligence models; and receive, from the first NE, a poisoning detection result comprising a model poisoning score indicating a likelihood that at least one of the one or more second artificial intelligence models is in a poisoned state.

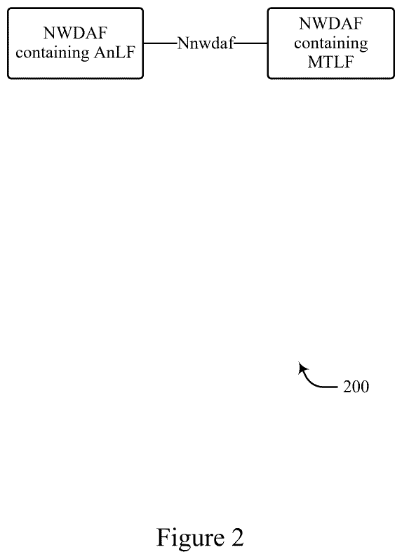

FIG. 2 illustrates an example architecture 200 for trained ML model provisioning. A wireless communications system architecture (e.g., as described in 3GPP technical specification (TS) 23.288) allows NWDAF containing analytics logical function (AnLF) to use trained ML model provisioning services from another NWDAF containing model training logical function (MTLF). Current wireless communications systems, however, may not support techniques to identify data poisoning attacks in model training and/or usage phases in FL procedures. Sec, e.g., analytics logical function and model training logical function as described in clause 5.1 of TS 23.288.

Aspects of explainable, fair, and robust machine learning are studied in 3GPP technical report (TR) 28.908 as a part of trustworthy machine learning. However, the current TR does not support identification of poisoning attacks in a FL setting where the poisoning potentially originates from the client nodes or client NWDAFs in case of FL training as specified in clause 6.2C of TS 23.288.

Some previous solutions have presented proposals for detecting and mitigating model poisoning in FL scenarios. For instance, a first proposed solution employs a multi-level defense mechanism that can act in solo or concert including a first statistical technique (an analysis of class specific misclassification rate), a second neural network activation clustering technique, and a third technique for a feedback loop for clients to apply detection techniques locally. For instance, the first statistical technique is statistical method of classification distribution and is done during the testing phase with a dataset with true labels with the server; the second technique is clustering of the activation nodes after dimension reductions; and the third technique involves trusted local clients checks for both activation clustering as well as misclassification distribution for detecting poisonous updates and gives feedback to the server.

The first proposed solution, however, exhibits a number of drawbacks. For instance, depending on the number of activated nodes in the neural network which can be all activated nodes in a worst case and more predominate in case of sponge poisoning attacks, the computation overhead for clustering can be very high. Further, although misclassification of distribution can be theoretically efficient for simple model architectures, especially for large language models or models intended to generate data, associated metrics can potentially fail. Finally, for the feedback loop, the client operating is assumed to be trusted. Detection of trusted clients, however, can be very difficult given the FL environment and in cases where malicious clients participate in the feedback, the poisoning attack can prove to be more damaging than without this defense mechanism.

In a second proposed solution a system is proposed for preventing poisoning attacks in machine learning systems in real time. This can be done by blocking the injection of abnormal data used to train the machine learning by blocking certain data from entering the machine learning training dataset in real time, blocking certain interactions from being completed, or placing holds on certain resources or users detected by ensembles of machine learning models. The proposed solution, for instance, involves deployment of a population of machine learning models configured to: adaptively monitor interactions between one or more entities, store the interaction data in a historical database, identify a subset of the anomaly injected data, and remove poisoned models from the model population.

The second proposed solution, however, also exhibits a number of drawbacks. For instance, inspection of data in a machine learning scenario is time consuming and energy expensive given the amount of data to be processed and analyzed in a wireless network. Moreover, in FL scenarios, client data cannot be inspected (e.g., FL is privacy protected by design).

Accordingly, solutions described in the present disclosure provide ways for identification of poisoning attacks and poisonous nodes in FL scenarios. In implementations, an XAIF first measures a distance metric between a model from a previous round of training (e.g., a global model) and a new aggregated model and performs client-based poisoning detection in scenarios where the distance metric exceeds a threshold value. Implementations can thus reduce computation complexity as compared with previous solutions described above. Furthermore, when the client local models are inspected for poisoned or non-poisoned updates, a feature importance is generated in addition to checking for correct predictions, which can be manipulated by the clients. Whereas previous solutions such as described above attempt to detect model poisoning by inspection of the data, such approaches may not be valid in FL scenarios due to the privacy protected design.

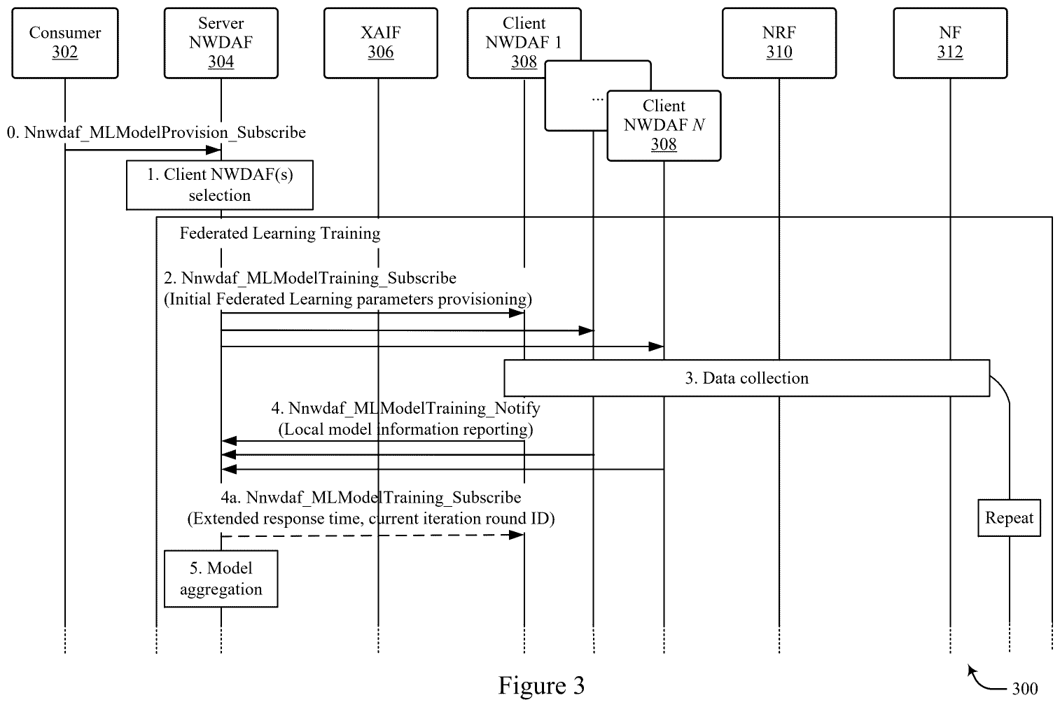

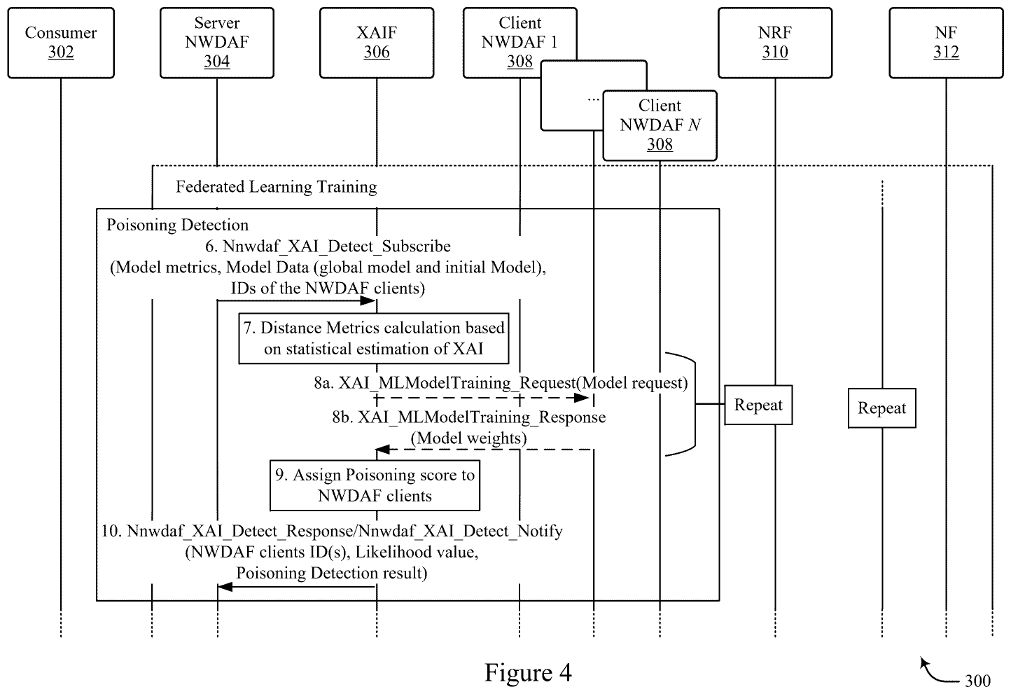

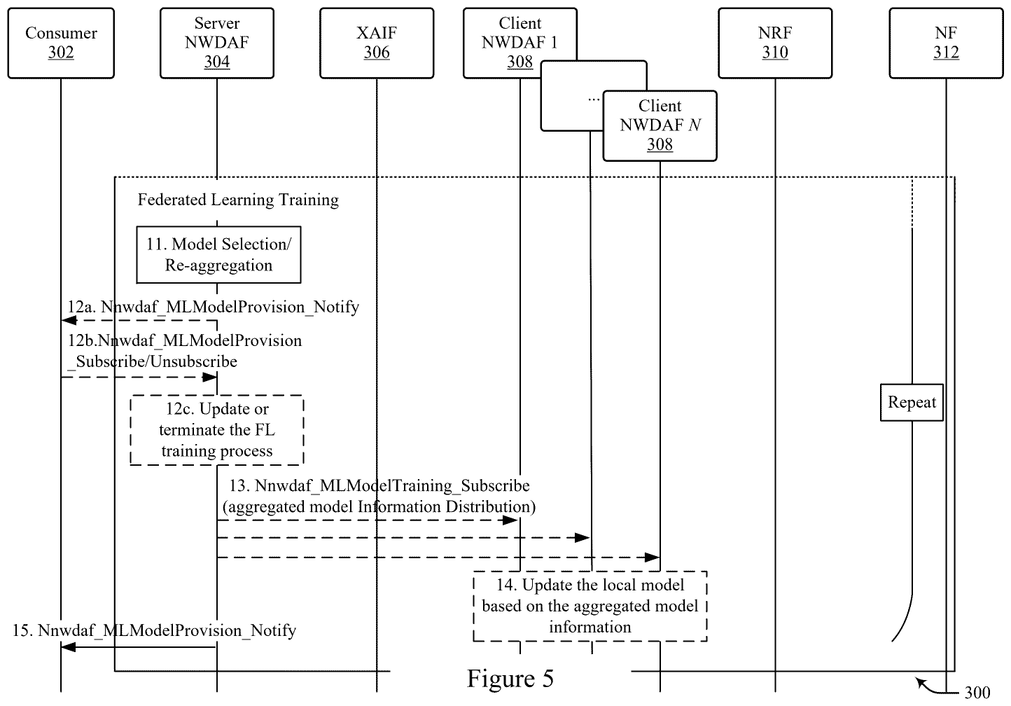

FIGS. 3-5 illustrate an example procedure 300 for model poisoning detection in accordance with aspects of the present disclosure. In the procedure 300, an XAIF is implemented to perform model poisoning detection, such as in a FL scenario. As further detailed below, the XAIF may be implemented as a network function in a network domain and/or a management function in a network management domain.

The procedure 300 includes a consumer 302, server NWDAF 304, XAIF 306, client NWDAFs 308, network repository function (NRF) 310, and network function (NF) 312. The procedure 300 includes the following steps:

Step 0: The consumer 302 (e.g., a ML model consumer) sends a subscription request to the server NWDAF 304 (e.g., a FL server NWDAF) to retrieve an ML model, such as using Nnwdaf_MLModelProvision service as defined in clause 7.5 of TS 23.288 including analytics ID, ML model metric (e.g., ML model accuracy), accuracy reporting interval, and/or pre-determined status, e.g., ML model accuracy threshold or time when the ML model is expected.

In implementations the ML model accuracy threshold can be used to indicate the target ML model accuracy of the training process and the server NWDAF 304 may stop the training process when the ML model accuracy threshold is achieved during the training process. If the consumer 302 (e.g. the NWDAF containing AnLF or NWDAF containing MTLF) provides the time when the ML model is expected, the server NWDAF 304 can take this information into account to decide the maximum response time for its FL Client NWDAF(s) 308.

Step 1: The Server NWDAF 304 selects client NWDAF(s) 308 containing MTLF (FL Client NWDAF(s)) such as described in clause 6.2C.2.1 of TS 23.288.

Step 2: The server NWDAF 304 sends a Nnwdaf_MLModelTraining_Subscribe or Nnwdaf_MLModelTrainingInfo_Request to the selected client NWDAF(s) 308 containing MTLF (FL Client NWDAF(s)), which participate in the FL to perform the local model training and determine the interim local ML model information based on the input parameter in the request from server NWDAF 304. The request includes ML model metrics, an initial ML model, and the maximum response time, and the client NWDAFs 308 can report the interim local ML model information to the server NWDAF 304 before the maximum response time elapses.

Step 3: [Optional] Each client NWDAF 308 collects its local data by using the current mechanism in clause 6.2 of TS 23.288 if the client NWDAF 308 does not have local data available already.

Step 4: During a FL training procedure, each client NWDAF 308 further trains the ML model provided by the server NWDAF 304 based on its own data and reports the interim local ML model information to the server NWDAF 304 in Nnwdaf_MLModelTraining_Notify or Nnwdaf_MLModelTrainingInfo_Request response. The Nnwdaf_MLModelTraining_Notify or Nnwdaf_MLModelTrainingInfo_Request response may also include the status report of FL training that includes local ML model metrics computed by the client NWDAFs 308 and training input data information (e.g., areas covered by the data set, sampling ratio, maximum value and/or minimum value of each dimension of data, etc.) in the client NWDAFs 308.

The Nnwdaf_MLModelTraining_Notify or Nnwdaf_MLModelTrainingInfo_Response also includes the global ML model accuracy when the ML model accuracy check flag is included in the Nnwdaf_MLModelTraining_Subscribe or Nnwdaf_MLModelTrainingInfo_Request (e.g., as described in step 13), and the global ML model accuracy can be calculated by the client NWDAFs 308 using the local training data as the testing dataset.

The parameters in characteristics of local training dataset can be up to particular implementation. The local ML model, which is sent from the client NWDAF(s) 308 to the server NWDAF 304 during the FL training process, represents information used by the server NWDAF 304 to build the aggregated model.

If the client NWDAFs 308 are not able to complete the training of the interim local ML model within the maximum response time provided by the server NWDAF 304, the client NWDAFs 308 can send the delay event notification that includes the delay event indication, an optional cause code (e.g. local ML model training failure, more time necessary for local ML model training) and the expected time to complete the training if available to the server NWDAF 304 before the maximum response time elapses.

Step 4a: [Optional] If server NWDAF 304 receives notification/response that the client NWDAFs 308 are not able to complete the training within the maximum response time, the server NWDAF 304 may send to the client NWDAFs 308 a new maximum response time in Nnwdaf_MLModelTraining_Subscribe or Nnwdaf_MLModelTrainingInfo_Request, before which the client NWDAFs 308 are to report the interim local ML model information to the server NWDAF 304. Otherwise, the server NWDAF 304 may indicate to the client NWDAFs 308 to skip reporting for this iteration. The server NWDAF 304 can include the current iteration round ID in the message to indicate that the request is to modify the training parameters of the current iteration round. Alternatively or additionally, the server NWDAF 304 may inform the client NWDAFs 308 to cease the ML model training by sending a termination request and an indication to report back the current local ML model updates.

Step 5: The server NWDAF 304 aggregates the local ML model information retrieved at step 4 to update the global ML model. The server NWDAF 304 may also compute the global ML model metric, e.g., based on the local ML model metric(s) and/or by applying the global model on the validation dataset (if available). The server NWDAF 304 may update the global ML model each time a client NWDAF 308 provides updated local ML model information, and/or the server NWDAF 304 may decide to wait for local ML model information from a set of client NWDAFs 308 before updating the global ML model.

If the server NWDAF 304 provides the maximum response time for the client NWDAFs 308 to provide the interim local ML model information in step 2, or the new maximum response time in step 4a, the server NWDAF 304 can decide either to wait for the client NWDAF(s) 308 which have not yet provided their interim local ML model within the new maximum response time or to aggregate only the retrieved local ML model information instances to update global ML model. The server NWDAF 304 can make this decision considering the notification/response from the client NWDAF 308 or, if the notification is not received, based on local configuration.

Step 6: After the model is aggregated in step 5, the server NWDAF 304 (e.g., if capable of XAI assistance/data poisoning detection assistance) sends Nnwdaf_XAI_Subscribe request to the XAIF 306 to initiate the poisoning detection with the global ML model metric if available (e.g., accuracy, precision, time of training, etc.), model data (e.g., global model and initial model if available), and IDs of the client NWDAF(s) 308 that participated in the training process.

In implementations, step 6 involves one or more preconditions. For instance, the XAIF 306 registers to NRF 310 with its data poisoning detection capability information. Alternatively or additionally, if a NWDAF offers XAI service, such NWDAF can register to the NRF 310 with its XAI/data poisoning detection capability information. Further, the server NWDAF 304 and/or client NWDAFs 308 can register to the NRF 310 with their XAI assistance/data poisoning detection assistance capability information.

Step 7: The XAIF 306 calculates distance metric values (e.g., Chebyshev distance for images, hamming distance for text, etc.) based on the XAI statistical estimation of the models (current models and/or previous models) and checks if the distance metric values are within the range of a distance threshold value. In implementations a distance between the statistical estimation can represent that the explanation of a same target (e.g., test data used for measurement, such as measurement of the distance metric values) does not change significantly with a round of training. Alternatively or additionally, the XAIF 306 can calculate the distance metric values based on operator implementation.

Step 8a: [Optional] If the distance metric values exceed the distance threshold value in the step 7, the XAIF 306 can query the AI models from the client NWDAFs 308 using XAI_MLModelTraining_Request, the IDs of which are retrieved from the server NWDAF 304 at step 6.

Step 8b: [Optional] The client NWDAFs 308 send their locally trained model(s) to the XAIF 306 to be evaluated further using the XAI_MLModelTraining_Response. The XAIF 306 may select a subset of the models (e.g., where the accuracy of the global model is at convergence with enough rounds of training rounds and a threshold number of the client NWDAFs 308 are trusted by the server via a robust model) or all of the received the models and perform explanation (e.g., feature importance along with the true labels) of the models/subset of models on an evenly distributed dataset. The XAIF 306 can measure the difference of the explanation (e.g., using Euclidean distance and/or other distance metrics) of the local models with the model (e.g., global model) from the previous global round of training.

Alternatively or additionally, apart from the feature importance produced by the XAIF 306, activated neurons during inference of the local models and/or inference time for the same data point used by the previous global model and the new local model can also be bootstrapped with this process for further robustness of the poisoning detection. These differences in explanation can be indicators of the models being poisoned and hence can be used in step 9 for assigning poisoning scores to the client NWDAFs 308.

Step 9: The XAIF 306 determines the likelihood of whether model poisoning occurred at the client NWDAFs 308 based on the distance metric values of statistical estimation calculated from the local model of the client NWDAFs 308 and the previous global model. The XAIF 306 generates a model poisoning likelihood value (e.g., a numeric value and/or percentage value) and model poisoning detection result, e.g., poisoned/not poisoned, targeted/non-targeted, etc.

Step 10: When the XAIF 306 with poisoning detect capabilities completes the detection for the client NWDAFs 308, the XAIF 306 notifies the server NWDAF 304 with the subscription ID of the session, client NWDAF 308 ID(s), model poisoning likelihood value(s), and model poisoning detection result(s) (e.g., poisoned/not poisoned, targeted/non-targeted, etc.) in response to the subscription request from step 6.

Alternately or additionally, the XAIF 306 can send Nnwdaf_XAI_Detect_Nofity any time when ready with the subscription ID of the session, client NWDAF 308 ID(s), model poisoning likelihood value, ML model identifier(s), and model poisoning detection result (e.g., poisoned/not poisoned, targeted/non-targeted, etc.) in response to the subscription request of step 6.

Step 11: The server NWDAF 304 selects the model that is to be trained in the next rounds of training and/or model to be used for inference. Model selection can be based on the input from the XAIF 306 from step 10, e.g., the model poisoning likelihood of the client NWDAFs 308 and the model poisoning detection result. Based on the model poisoning likelihood and model poisoning detection result the server NWDAF 304 can perform aggregation of the model only from the client NWDAFs 308 whose models are determined as not poisoned. If all the of the client NWDAFs 308 are determined to be poisoned, then the model can be discarded and the next round of training can be done with a previous model and/or using the aggregated model from step 5 and using updates from non-poisoned client NWDAFs 308. Further the poisoned model specific to the indicated ML model identifier(s) can be discarded.

Step 12a: [Optional] Based on the consumer 302 request in step 0, the server NWDAF 304 can send a Nnwdaf_MLModelProvision_Notify message to update the ML model metric to the consumer 302 periodically (e.g., a certain number of training rounds and/or every t min) and/or dynamically when a pre-determined status is achieved, e.g., the ML model accuracy threshold is achieved and/or training time expires.

Step 12b: [Optional] The consumer 302 determines whether the current model can fulfil a requirement (e.g., a global ML model metric is satisfactory for the consumer 302) and determines to stop or continue the training process. The consumer 302 can re-invoke

Nnwdaf_MLModelProvision_Subscribe service operation as used in step 0 to continue the training process or invokes Nnwdaf_MLModelProvision_Unsubscribe service operation to stop the training process.

Step 12c: [Optional] Based on the subscription request sent from the consumer 302 in step 12b, the server NWDAF 304 updates or terminates the current FL training process. If the server NWDAF 304 received a request in step 12b to stop the FL training process, steps 13 and 14 can be skipped.

Step 13: If the FL training process continues, the server NWDAF 304 may determine client NWDAFs 308 (e.g., as described in clause 6.2C.2.3 of TS 23.288) and send Nnwdaf_MLModelTraining_Subscribe or Nnwdaf_MLModelTrainingInfo_Request that includes the aggregated ML model information to selected client NWDAF(s) 308 for a next round of federated training. The request may also include the ML Model accuracy check flag that indicates to the client NWDAF(s) 308 to use the local training data as the testing dataset to calculate the model accuracy of the global ML model provided by the server NWDAF 304.

Step 14: Each client NWDAF 308 updates its own ML model based on the aggregated ML model information distributed by the server NWDAF 304 at step 13. The steps 3-14 can be repeated until a training termination condition (e.g., maximum number of iterations and/or the result of a loss function is lower than a threshold) is reached.

When the federated training procedure is complete, the server NWDAF 304 can request that the client NWDAF(s) 308 terminate the FL procedure by invoking Nnwdaf_MLModelTraining_Unsubscribe service with a cause code that the FL training process has finished and optionally with final aggregated ML model information. The client NWDAF(s) 308 can terminate the local model training and, if the final aggregated ML model information is received from the server NWDAF 304, the client NWDAF(s) 308 can store the final aggregated ML model information for further use.

Step 15: After the training process is complete, the server NWDAF 304 may send Nnwdaf_MLModelProvision_Notify that includes the globally optimal ML model information to the consumer 302.

As mentioned above, the XAIF may be implemented as one or more of a network function or a management function. Accordingly, Table 1 below provides example network function services provided by the server NWDAF 304 and the XAIF 306 in a network domain, and Table 2 provides example network function services provided by the XAIF 306.

TABLE 1
Services provided by NWDAF and XAIF (network domain)

| | | Any additional |
|---|---|---|
| | | information as |
| | | per the |
| Service name | Description | embodiment 3 |
| Nnwdaf_XAI_{—} | This service enables the | Consumer: XAIF, |
| Detect | initiation of the poisoning | Server NWDAF |
| | detection by sending the model | |
| | metrics, model data (global | |
| | model and initial model) and IDs | |
| | of the NWDAF clients to the | |
| | XAIF. Also, this service enables | |
| | the consumer to receive the | |
| | detection result of poisoning | |
| | clients with IDs, likelihood | |
| | value and Poisoning detection | |
| | result. | |
| XAI_{—} | This service enables the | Consumer: Client |
| MLModelTraining | consumer to send request for | NWDAF and |
| | models and receive the models | XAIF |
| | of the entities involved in local | |
| | training of the models (Client | |
| | NWDAFs) | |

TABLE 2
Services provided by XAIF (network domain)

| | Service | Operation | Example |
|---|---|---|---|
| Service Name | Operation | Semantics | Consumer(s) |
| Nnwdaf_XAI_Detect | Subscribe | Subscribe/ | XAIF, |
| | Unsubscribe | Notify | NWDAF |
| | Notify | | |
| XAI_MLModelTraining | Request | Request/ | Client |
| | | Response | NWDAFs, |
| | | | XAIF |

According to implementations where the XAIP 306 is implemented in a management domain, Table 3 below provides example services provided by the server NWDAF 304 and the XAIF 306, and Table 4 provides example services provided by the XAIF 306.

TABLE 3
NF Services provided by NWDAF
and XAIF (management domain)

| | | Any additional |
|---|---|---|
| | | information as |
| | | per the |
| Service name | Description | embodiment 3 |
| Nnwdaf_XAI_{—} | This service enables the | Consumer: XAIF, |
| Detect | initiation of the poisoning | Server NWDAF |
| | detection by sending the model | |
| | metrics, model data (global | |
| | model and initial model) and IDs | |
| | of the NWDAF clients to the | |
| | XAIF. Also, this service enables | |
| | the consumer to receive the | |
| | detection result of poisoning | |
| | clients with IDs, likelihood | |
| | value and Poisoning detection | |
| | result. | |
| XAI_{—} | This service enables the | Consumer: Client |
| MLModelTraining | consumer to send request for | NWDAF and |
| | models and receive the models | XAIF |
| | of the entities involved in local | |
| | training of the models (Client | |
| | NWDAFs) | |

TABLE 4
NF Services provided by XAIF (management domain)

| | Service | Operation | Example |
|---|---|---|---|
| Service Name | Operation | Semantics | Consumer(s) |
| Nnwdaf_XAI_Detect | Subscribe | Subscribe/ | XAIF, |
| | Unsubscribe | Notify | NWDAF |
| | Notify | | |
| XAI_MLModelTraining | Request | Request/ | Client |
| | | Response | NWDAFs, |
| | | | XAIF |

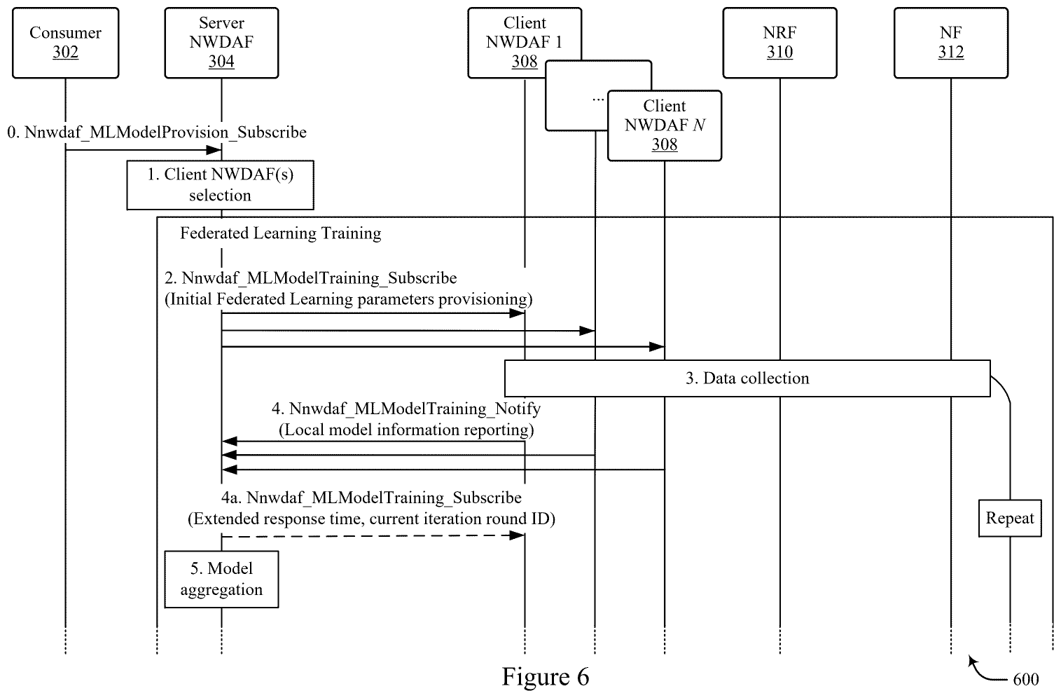

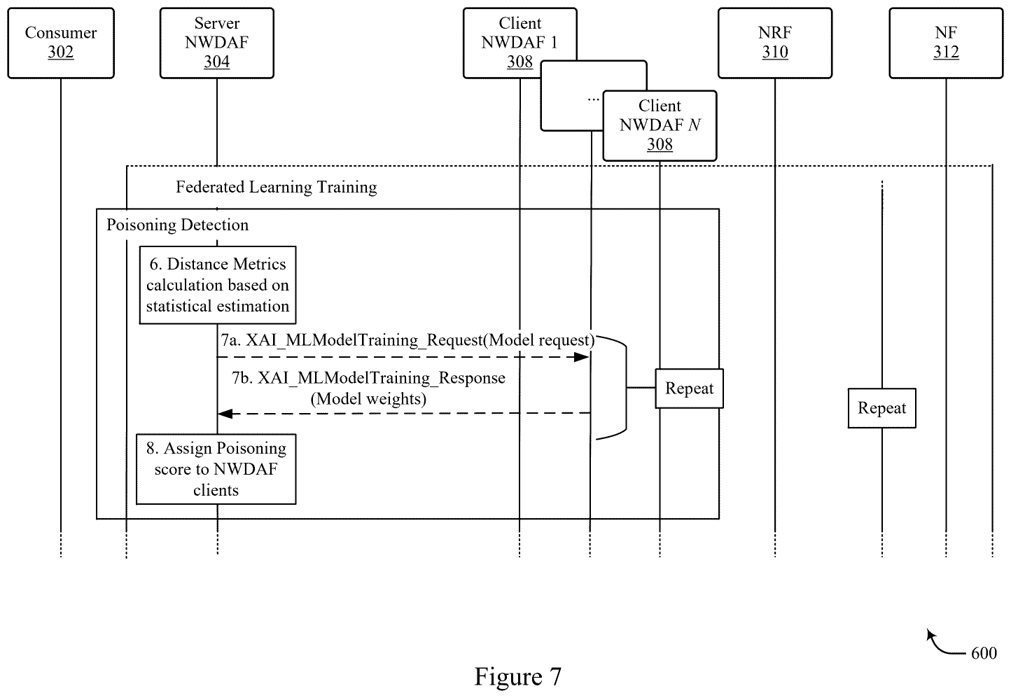

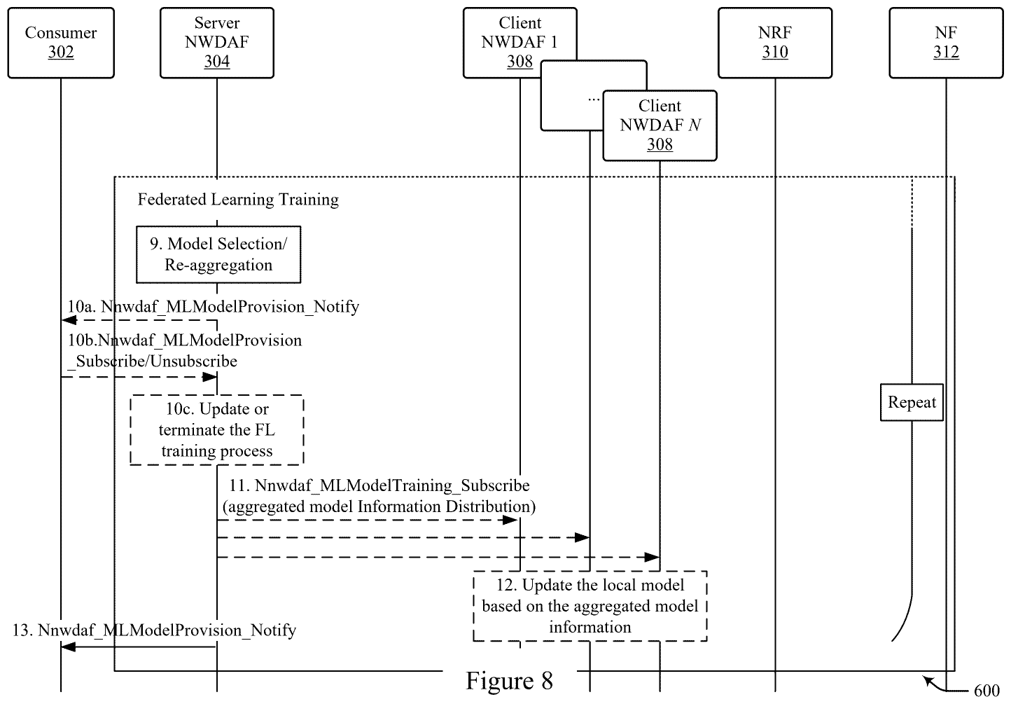

FIGS. 6-8 illustrate an example procedure 600 for model poisoning detection in accordance with aspects of the present disclosure. In the procedure 600, poisoning detection services are provided by the server NWDAF 304. The procedure 600, for example, can be implemented additionally or alternatively to the procedure 300.

The procedure 600 includes the following steps:

Step 0: The consumer 302 (e.g., NWDAF containing AnLF or NWDAF containing MTLF) sends a subscription request to the server NWDAF 304 to retrieve an ML model, using Nnwdaf_MLModelProvision service as defined in clause 7.5 of TS 23.288 including analytics ID, ML model metric (e.g., ML model accuracy), accuracy reporting interval, and pre-determined status, e.g., ML model accuracy threshold and/or time when the ML model is expected.

The ML model accuracy threshold can be used to indicate the target ML model accuracy of the training process and the server NWDAF 304 may stop the training process when the ML model accuracy threshold is achieved during the training process. If the consumer 302 provides the time when the ML model is expected, the server NWDAF 304 can utilize this information to determine to decide the maximum response time for its client NWDAF(s) 308.

Step 1: The server NWDAF 304 selects client NWDAF(s) 308 containing MTLF as described in clause 6.2C.2.1 of TS 23.288.

Step 2: The server NWDAF 304 sends a Nnwdaf_MLModelTraining_Subscribe or Nnwdaf_MLModelTrainingInfo_Request to the selected client NWDAFs 308 containing MTLF, which participate in the FL to perform the local model training and determine the interim local ML model information based on the input parameter in the request from the server NWDAF 304. The request includes ML model metric and initial ML model and also includes the maximum response time. For instance, the client NWDAFs 308 are to report the interim local ML model information to the server NWDAF 304 before the maximum response time elapses.

Step 3: [Optional] Each client NWDAF 308 collects its local data by using the current mechanism in clause 6.2 of TS 23.288 if the client NWDAF 308 does not have local data available already.

Step 4: During a FL training procedure, each client NWDAF 308 further trains the ML model provided by the server NWDAF 304 based on its own data and reports the interim local ML model information to the server NWDAF 304 in Nnwdaf_MLModelTraining_Notify or Nnwdaf_MLModelTrainingInfo_Request response. The Nnwdaf_MLModelTraining_Notify or Nnwdaf_MLModelTrainingInfo_Request response may also include the status report of FL training that includes local ML model metric computed by the client NWDAF 308 and training input data information (e.g., areas covered by the data set, sampling ratio, maximum and/or minimum of value of each dimension of data, etc.) in the client NWDAF 308. The Nnwdaf_MLModelTraining_Notify or Nnwdaf_MLModelTrainingInfo_Response also includes the global ML model accuracy when a ML model accuracy check flag is included in the Nnwdaf_MLModelTraining_Subscribe or Nnwdaf_MLModelTrainingInfo_Request (e.g., as described in step 11), and the global ML model accuracy is calculated by the client NWDAF 308 using the local training data as the testing dataset.

The parameters and characteristics of local training dataset can be up to a particular implementation. The local ML model, which is sent from the client NWDAF(s) 308 to the server NWDAF 304 during the FL training process, can represent information used by the server NWDAF 304 to build the aggregated model.

If the client NWDAF 308 is not able to complete the training of the interim local ML model within the maximum response time provided by the server NWDAF 304, the client NWDAF 308 can send the delay event notification that include the delay event indication, an optional cause code (e.g., local ML model training failure, more time necessary for local ML model training, etc.) and the expected time to complete the training if available to the server NWDAF 304 before the maximum response time elapses.

Step 4a: [Optional] If the server NWDAF 304 receives notification/response that the client NWDAF 308 is not able to complete the training within the maximum response time, the server NWDAF 304 may send to the client NWDAF 308 a new maximum response time in Nnwdaf_MLModelTraining_Subscribe or Nnwdaf_MLModelTrainingInfo_Request, before which the client NWDAF 308 is to report the interim local ML model information to the server NWDAF 304. The server NWDAF 304 may alternatively or additionally indicate to the client NWDAF 308 to skip reporting for this iteration. The server NWDAF 304 can include the current iteration round ID in the message to indicate that the request is to modify the training parameters of the current iteration round. Alternatively or additionally, the server NWDAF 304 may inform the client NWDAF 308 to cease the ML model training by sending termination request and to report back the current local ML model updates.

Step 5: The server NWDAF 304 can aggregate the local ML model information retrieved at step 4 to update the global ML model. The server NWDAF 304 may also compute the global ML model metric, e.g., based on the local ML model metric(s) and/or by applying the global model on the validation dataset (if available). The server NWDAF 304 may update the global ML model each time a client NWDAF 308 provides updated local ML model information, and/or the server NWDAF 304 may determine to wait for local ML model information from all client NWDAFs 308 before updating the global ML model.

If the server NWDAF 304 provides the maximum response time for the client NWDAF(s) 308 to provide the interim local ML model information (e.g., in step 2) or the new maximum response time (e.g., in step 4a), the server NWDAF 304 can determine either to wait for the client NWDAF(s) 308 which have not yet provided their interim local ML model within the new maximum response time or to aggregate only the retrieved local ML model information instances to update global ML model. The server NWDAF 304 can make this determination considering the notification/response from the client NWDAF(s) 308 or, if the notification is not received, based on local configuration.

Step 6: After model aggregation, the server NWDAF 304 can calculate the distance metric values (e.g., Chebyshev values for images, hamming distance for text, etc.) based on statistical estimation of the models (e.g., current models and/or previous models) and can check if the distance metric values is within a range of the distance value threshold.

In implementations a distance between the statistical estimation can represent that the explanation of a same target (e.g., test data used for measurement, such as measurement of the distance metric values) does not change significantly with a round of training. Alternatively or additionally, the server NWDAF 304 can calculate the distance metric values based on operator implementation.

Step 7a: [Optional] If the distance metric values exceed the distance threshold value in the step 6, the server NWDAF 304 can query the models from the client NWDAFs 308 using Nnwdaf_XAI_MLModelTraining_Subscribe, the IDs of which are retrieved from the server NWDAF 304.

Step 7b. [Optional] The client NWDAFs 308 can send their locally trained model(s) to the server NWDAF 304 to be evaluated further using the Nnwdaf_XAI_MLModelTraining_Notify. The server NWDAF 304 may select a subset of the models (e.g., where the accuracy of the global model is at convergence with enough rounds of training rounds and a threshold number of the client NWDAFs 308 are trusted by the server to have a robust model) or all of the models and perform explanation (e.g., feature importance along with the true labels) of the models/subset of models on an evenly distributed dataset. The server NWDAF 304 can measure the difference of the explanation (e.g., using Euclidean distance and/or other distance metrics) of the local models with the model from the previous global round of training.

Alternatively or additionally, apart from the feature importance produced by the server NWDAF 304, activated neurons during inference of the local models and/or inference time for the same data point used by the previous global model and the new local model can also be bootstrapped with this process for further robustness of the poisoning detection. These differences in explanation can be indicators of the models being poisoned and hence is used in step 8 for assigning poisoning scores to the client NWDAFs 308.

Step 8: The server NWDAF 304 can determine the likelihood that model poisoning occurred at the client NWDAFs 308 based on the distance metric values of statistical estimation calculated from the local model of the client NWDAFs 308 and the previous global model. The server NWDAF 304 can generate a model poisoning likelihood value ((e.g., a numeric value and/or percentage value), ML model identifier(s), and model poisoning detection result, e.g., poisoned/not poisoned, targeted/non-targeted, etc.

Step 9: The server NWDAF 304 selects the model that is to be trained in the next rounds of training and/or the models to be used for inference. Model selection can be based on the model poisoning likelihood of the client NWDAFs 308 and the model poisoning detection result. Based on the model poisoning likelihood and/or model poisoning detection result, the server NWDAF 304 can perform aggregation of the model from the client NWDAFs 308 whose models are not determined to be poisoned. If all the client NWDAFs 308 are determined to be poisoned, then the model can be discarded and the next round of training can be done with the previous model and/or using the model after the aggregation and using model updates from with non-poisoned clients NWDAFs 308. Further the poisoned model specific to the indicated ML model identifier(s) can be discarded.

Step 10a: [Optional] Based on the consumer 302 request in step 0, the server NWDAF 304 can send a Nnwdaf_MLModelProvision_Notify message to update the ML model metric to the consumer 302 periodically (e.g., a certain number of training rounds and/or every t min) and/or dynamically when a pre-determined status is achieved, e.g., the ML model accuracy threshold is achieved and/or training time expires.

Step 10b: [Optional] The consumer 302 can determine whether the current model can fulfil the requirement, e.g., a global ML model metric is satisfactory for the consumer 302 and determine to stop or continue the training process. The consumer 302 can re-invoke Nnwdaf_MLModelProvision_Subscribe service operation as used in step 0 to continue the training process or can invoke Nnwdaf_MLModelProvision_Unsubscribe service operation to stop the training process.

Step 10c: [Optional] Based on the subscription request sent from the consumer 302 in step 10b, the server NWDAF 304 can update or terminate the current FL training process. If the server NWDAF 304 received a request in step 10b to stop the FL training process, steps 11 and 12 can be skipped.

Step 11: If the FL training procedure continues, the server NWDAF 304 may determine client NWDAF 308 (s) (e.g., as described in clause 6.2C.2.3 of TS 23.288) and send Nnwdaf_MLModelTraining_Subscribe or Nnwdaf_MLModelTrainingInfo_Request that includes the aggregated ML model information to selected client NWDAF(s) 308 for a next round of FL training. The request may also include the ML model accuracy check flag that indicates that the client NWDAF(s) 308 are to use the local training data as a testing dataset to calculate the model accuracy of the global ML model provided by the server NWDAF 304.

Step 12: Each client NWDAF 308 can update its own ML model based on the aggregated ML model information distributed by the server NWDAF 304, e.g., at step 11.

Steps 3-12 can be repeated until a training termination condition (e.g., a maximum number of iterations and/or a result of a loss function is lower than a threshold) is reached. When the FL training procedure is complete, the server NWDAF 304 can request that the client NWDAF(s) 308 terminate the FL training procedure by invoking Nnwdaf_MLModelTraining_Unsubscribe service with a cause code that the FL training process has finished and optionally with the final aggregated ML model information. The client NWDAF(s) 308 may then terminate the local model training and if the final aggregated ML model information is received from the server NWDAF 304, the client NWDAF(s) 308 can store the final aggregated ML model information for further use.

Step 13: After the training process is complete, the server NWDAF 304 may send Nnwdaf_MLModelProvision_Notify that includes the globally optimal ML model information to the consumer 302.

Tables 5 and 6 below provide example services that may be provided by NWDAF such as in the context of the procedure 600.

TABLE 5
Services provided by NWDAF

| | | Any additional |
|---|---|---|
| | | information as |
| | | per the |
| Service name | Description | embodiment 3 |
| Nnwdaf_XAI_{—} | This service enables the consumer | Consumer: |
| MLModelTraining | to send request for models and | Client NWDAF |
| | receive the models of the entities | and Server |
| | involved in local training of the | NWDAF |
| | models (Client NWDAFs) | |

TABLE 6
Services provided by NWDAF

| | Service | Operation | Example |
|---|---|---|---|
| Service Name | Operation | Semantics | Consumer(s) |
| Nnwdaf_XAI_{—} | Subscribe | Subscribe/ | Client |
| MLModelTraining | Unsubscribe | Notify | NWDAF and |
| | Notify | | Server |
| | | | NWDAF |

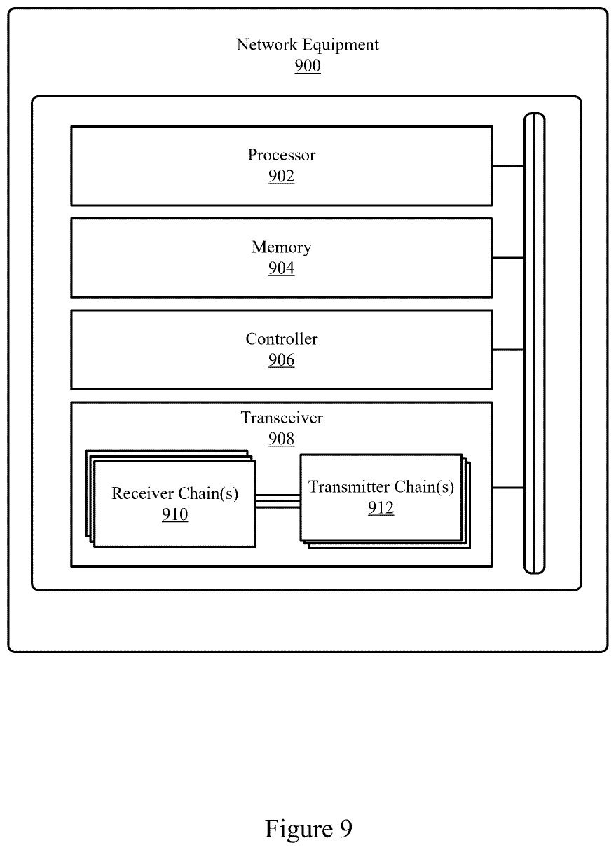

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein.

The NE 900 may be configured to or operable to support a means for generating a first distance value based at least in part on a comparison of one or more first artificial intelligence models and one or more second artificial intelligence models; comparing the first distance value to a distance value threshold; generating a flag to initiate poisoning score detection based at least in part on whether the first distance value exceeds the distance value threshold; and generating one or more model poisoning scores based at least in part on comparison of the first artificial intelligence model and one or more third artificial intelligent models in training.

Additionally, the NE 900 may be configured to or operable to support any one or combination of the method where the one or more first artificial intelligence models include one or more previously trained artificial intelligence models, the one or more second artificial intelligence models include one or more currently aggregated artificial intelligence models, and the one or more of third artificial intelligence models include one or more artificial intelligence models currently in training; generating the first distance value includes: generating a first feature representation of the one or more first artificial intelligence models, and a second feature representation of the one or more second artificial intelligence models; and generating the first distance value based at least in part on a distance between the first feature representation and the second feature representation; generating the first distance value includes: generating a first description of the one or more first artificial intelligence models, the first description including one or more of an image-based description or a text-based description of the one or more first artificial intelligence models; generating a second description of the one or more second artificial intelligence models, the second description including one or more of an image-based description or a text-based description of the one or more second artificial intelligence models; and generating the first distance value based at least in part on a distance between the first description including one or more of the image-based description or the text-based description of the one or more first artificial intelligence models and the second description including the one or more of an image-based description or a text-based description of the one or more second artificial intelligence models; the model poisoning score includes one or more of a numerical value or a percentage likelihood value that the one or more third artificial intelligence models are in a poisoned state.

Additionally, the NE 900 may be configured to or operable to support any one or combination of the method where the one or more third artificial intelligence models include one or more classes of artificial intelligence models, and wherein the method further includes generating a targeting indication including an indication of whether poisoning of the one or more third artificial intelligence models is targeted to at least one class of the one or more classes of artificial intelligence models; further including transmitting one or more of the model poisoning score, a client identifier, or a model identifier to a second NE; the first NE includes an artificial intelligence network function and the second NE includes a server NWDAF; further including: determining that the first distance value exceeds the distance value threshold; receiving, from one or more client NWDAFs and based at least in part on the first distance value exceeding the distance value threshold, the one or more third artificial intelligence models; generating a second distance value based at least in part on a comparison of the one or more first artificial intelligence models and the one or more third artificial intelligence models; and generating the flag to initiate the poisoning score detection further based at least in part on whether the second distance value exceeds the distance value threshold; the model poisoning score includes a likelihood that poisoning of the one or more third artificial intelligence models occurred via the one or more client NWDAFs; the first NE includes a server NWDAF; further including: receiving, from a second NE, a subscription request for poisoning detection for the one or more third artificial intelligence models; and transmitting, to the second NE, a poisoning detection result including the model poisoning score; further including: receiving, from the second NE, one or more identifiers for one or more third NE that participated in training the one or more third artificial intelligence models; and assigning the model poisoning score to at least one of the one or more third NE.

Additionally, or alternatively, the NE 900 may support at least one memory (e.g., the memory 904) and at least one processor (e.g., the processor 902) coupled with the at least one memory and configured to cause the NE to generate a first distance value based at least in part on a comparison of one or more first artificial intelligence models and one or more second artificial intelligence models; compare the first distance value to a distance value threshold; generate a flag to initiate poisoning score detection based at least in part on whether the first distance value exceeds the distance value threshold; and generate one or more model poisoning scores based at least in part on comparison of the first artificial intelligence model and one or more third artificial intelligent models in training.

Additionally, the NE 900 may be configured to support any one or combination of where the one or more first artificial intelligence models include one or more previously trained artificial intelligence models, the one or more second artificial intelligence models include one or more currently aggregated artificial intelligence models, and the one or more of third artificial intelligence models include one or more artificial intelligence models currently in training; to generate the first distance value, the at least one processor is configured to cause the first NE to: generate a first feature representation of the one or more first artificial intelligence models, and a second feature representation of the one or more second artificial intelligence models; and generate the first distance value based at least in part on a distance between the first feature representation and the second feature representation; to generate the first distance value, the at least one processor is configured to cause the first NE to: generate a first description of the one or more first artificial intelligence models, the first description including one or more of an image-based description or a text-based description of the one or more first artificial intelligence models; generate a second description of the one or more second artificial intelligence models, the second description including one or more of an image-based description or a text-based description of the one or more second artificial intelligence models; and generate the first distance value based at least in part on a distance between the first description including one or more of the image-based description or the text-based description of the one or more first artificial intelligence models and the second description including the one or more of an image-based description or a text-based description of the one or more second artificial intelligence models; the model poisoning score includes one or more of a numerical value or a percentage likelihood value that the one or more third artificial intelligence models are in a poisoned state.

Additionally, the NE 900 may be configured to support any one or combination of where the one or more third artificial intelligence models include one or more classes of artificial intelligence models, and wherein the at least one processor is configured to cause the first NE to generate a targeting indication including an indication of whether poisoning of the one or more third artificial intelligence models is targeted to at least one class of the one or more classes of artificial intelligence models; the at least one processor is configured to cause the first NE to transmit one or more of the model poisoning score, a client identifier, or a model identifier to a second NE; the first NE includes an artificial intelligence network function and the second NE includes a server NWDAF; determine that the first distance value exceeds the distance value threshold; receive, from one or more client NWDAFs and based at least in part on the first distance value exceeding the distance value threshold, one or more third artificial intelligence models; generate a second distance value based at least in part on a comparison of the one or more first artificial intelligence models and one or more third artificial intelligence models; and generate the flag to initiate the poisoning score detection further based at least in part on whether the second distance value exceeds the distance value threshold; the model poisoning score includes a likelihood that poisoning of the one or more third artificial intelligence models occurred via the one or more client NWDAFs; the first NE includes a server NWDAF; receive, from a second NE, a subscription request for poisoning detection for the one or more third artificial intelligence models; and transmit, to the second NE, a poisoning detection result including the model poisoning score; receive, from the second NE, one or more identifiers for one or more third NE that participated in training the one or more third artificial intelligence models; and assign the model poisoning score to at least one of the one or more third NE.

The NE 900 may be configured to or operable to support a means for transmitting, to a first NE, a subscription request for poisoning detection for one or more third artificial intelligence models; and receiving, from the first NE, a poisoning detection result including a model poisoning score indicating a likelihood that at least one of the one or more third artificial intelligence models is in a poisoned state.

Additionally, the NE 900 may be configured to or operable to support any one or combination of the method further comprising where the poisoning detection result includes an indication that at least one of the one or more third artificial intelligence models is likely in a poisoned state, and a targeting indication including an indication of whether poisoning of the at least one of the one or more third artificial intelligence models is targeted to at least one class of one or more classes of artificial intelligence models; further including transmitting, to the first NE, one or more identifiers for one or more third NE that participated in training of the one or more second artificial intelligence models, wherein the poisoning detection result is associated with at least one of the one or more third NE; selecting one or more candidate artificial intelligence models from the one or more third artificial intelligence models based at least in part on the poisoning detection result indicating that the one or more candidate artificial intelligence models are likely not in a poisoned state; and utilizing the one or more candidate artificial intelligence models for one or more of model training or data inference; determining, based at least in part on the poisoning detection result, that the one or more third artificial intelligence models are likely in a poisoned state; discarding the one or more second artificial intelligence models; and excluding one or more poisoned clients associated with the one or more third artificial intelligence models likely in a poisoned state from taking part in one or more next rounds of FL model training.

Additionally, or alternatively, the NE 900 may support at least one memory (e.g., the memory 904) and at least one processor (e.g., the processor 902) coupled with the at least one memory and configured to cause the NE to transmit, to a first NE, a subscription request for poisoning detection for one or more third artificial intelligence models; and receive, from the first NE, a poisoning detection result including a model poisoning score indicating a likelihood that at least one of the one or more third artificial intelligence models is in a poisoned state.

Additionally, the NE 900 may be configured to support any one or combination of where the poisoning detection result includes an indication that at least one of the one or more third artificial intelligence models is likely in a poisoned state, and a targeting indication including an indication of whether poisoning of the at least one of the one or more third artificial intelligence models is targeted to at least one class of one or more classes of artificial intelligence models; the at least one processor is configured to cause the second NE to transmit, to the first NE, one or more identifiers for one or more third NE that participated in training of the one or more second artificial intelligence models, wherein the poisoning detection result is associated with at least one of the one or more third NE; the at least one processor is configured to cause the second NE to: select one or more candidate artificial intelligence models from the one or more third artificial intelligence models based at least in part on the poisoning detection result indicating that the one or more candidate artificial intelligence models are likely not in a poisoned state; and utilize the one or more candidate artificial intelligence models for one or more of model training or data inference; the at least one processor is configured to cause the second NE to: determine, based at least in part on the poisoning detection result, that the one or more third artificial intelligence models are likely in a poisoned state; discard the one or more second artificial intelligence models; and exclude one or more poisoned clients associated with the one or more third artificial intelligence models likely in a poisoned state from taking part in one or more next rounds of FL model training.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

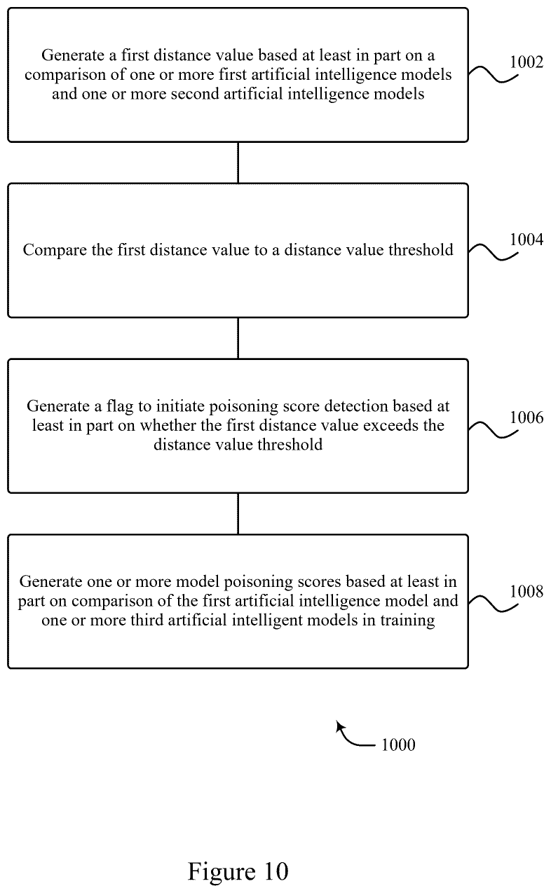

FIG. 10 illustrates a flowchart of a method 1000 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include generating a first distance value based at least in part on a comparison of one or more first artificial intelligence models and one or more second artificial intelligence models. The operations of 1002 may be performed in accordance with examples as described herein. In some implementations, aspects of the operations of 1002 may be performed by a NE as described with reference to FIG. 9.

At 1004, the method may include comparing the first distance value to a distance value threshold. The operations of 1004 may be performed in accordance with examples as described herein. In some implementations, aspects of the operations of 1004 may be performed by a NE as described with reference to FIG. 9.

At 1006, the method may include generating a flag to initiate poisoning score detection based at least in part on whether the first distance value exceeds the distance value threshold. The operations of 1006 may be performed in accordance with examples as described herein. In some implementations, aspects of the operations of 1006 may be performed a NE as described with reference to FIG. 9.

At 1008, the method may include generating one or more model poisoning scores based at least in part on comparison of the first artificial intelligence model and one or more third artificial intelligent models in training. The operations of 1008 may be performed in accordance with examples as described herein. In some implementations, aspects of the operations of 1008 may be performed a NE as described with reference to FIG. 9.

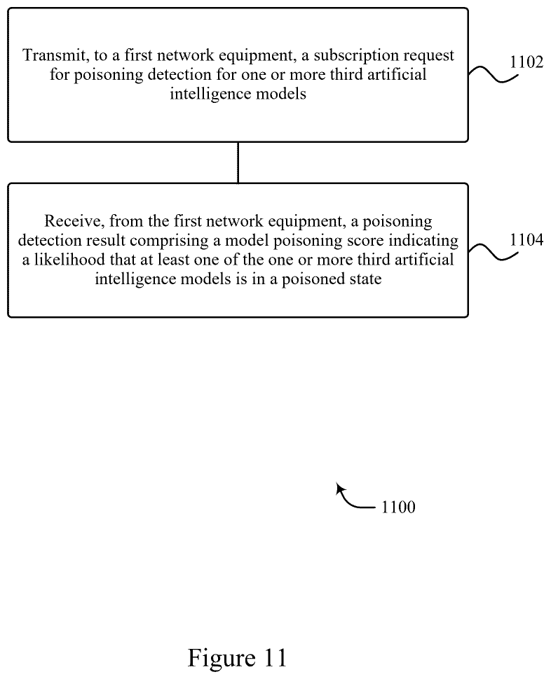

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting, to a first NE, a subscription request for poisoning detection for one or more third artificial intelligence models. The operations of 1102 may be performed in accordance with examples as described herein. In some implementations, aspects of the operations of 1102 may be performed by a NE as described with reference to FIG. 9.

At 1104, the method may include receiving, from the first NE, a poisoning detection result comprising a model poisoning score indicating a likelihood that at least one of the one or more third artificial intelligence models is in a poisoned state. The operations of 1104 may be performed in accordance with examples as described herein. In some implementations, aspects of the operations of 1104 may be performed by a NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network equipment for wireless communication, comprising:
at least one memory; and
at least one processor coupled with the at least one memory and configured to cause the first network equipment to:
generate a first distance value based at least in part on a comparison of one or more first artificial intelligence models and one or more second artificial intelligence models;
compare the first distance value to a distance value threshold;
generate a flag to initiate poisoning score detection based at least in part on whether the first distance value surpasses the distance value threshold; and
generate one or more model poisoning scores based at least in part on comparison of the first artificial intelligence model and one or more third artificial intelligent models in training.

2. The first network equipment of claim 1, wherein the one or more first artificial intelligence models comprise one or more previously trained artificial intelligence models, the one or more second artificial intelligence models comprise one or more currently aggregated artificial intelligence models, and the one or more of third artificial intelligence models comprise one or more artificial intelligence models currently in training.

3. The first network equipment of claim 1, wherein to generate the first distance value, the at least one processor is configured to cause the first network equipment to:
generate a first feature representation of the one or more first artificial intelligence models, and a second feature representation of the one or more second artificial intelligence models; and
generate the first distance value based at least in part on a distance between the first feature representation and the second feature representation.

4. The first network equipment of claim 1, wherein to generate the first distance value, the at least one processor is configured to cause the first network equipment to:
generate a first description of the one or more first artificial intelligence models, the first description comprising one or more of an image-based description or a text-based description of the one or more first artificial intelligence models;
generate a second description of the one or more second artificial intelligence models, the second description comprising one or more of an image-based description or a text-based description of the one or more second artificial intelligence models; and
generate the first distance value based at least in part on a distance between the first description comprising one or more of the image-based description or the text-based description of the one or more first artificial intelligence models and the second description comprising the one or more of an image-based description or a text-based description of the one or more second artificial intelligence models.

5. The first network equipment of claim 1, wherein the model poisoning score comprises one or more of a numerical value or a percentage likelihood value that the one or more third artificial intelligence models are in a poisoned state.

6. The first network equipment of claim 1, wherein the one or more third artificial intelligence models comprise one or more classes of artificial intelligence models, and wherein the at least one processor is configured to cause the first network equipment to generate a targeting indication comprising an indication of whether poisoning of the one or more third artificial intelligence models is targeted to at least one class of the one or more classes of artificial intelligence models.

7. The first network equipment of claim 1, wherein the at least one processor is configured to cause the first network equipment to transmit one or more of the model poisoning score, a client identifier, or a model identifier to a second network equipment.

8. The first network equipment of claim 7, wherein the first network equipment comprises an artificial intelligence network function and the second network equipment comprises a server network data analytics function (NWDAF).

9. The first network equipment of claim 1, wherein the at least one processor is configured to cause the first network equipment to:
determine that the first distance value exceeds the distance value threshold;
receive, from one or more client network data analytics functions (NWDAFs) and based at least in part on the first distance value exceeding the distance value threshold, one or more third artificial intelligence models;
generate a second distance value based at least in part on a comparison of the one or more first artificial intelligence models and one or more third artificial intelligence models; and
generate the flag to initiate the poisoning score detection further based at least in part on whether the second distance value exceeds the distance value threshold.

10. The first network equipment of claim 9, wherein the model poisoning score comprises a likelihood that poisoning of the one or more third artificial intelligence models occurred via the one or more client NWDAFs.

11. The first network equipment of claim 1, wherein the first network equipment comprises a server network data analytics function (NWDAF).

12. The first network equipment of claim 1, wherein the at least one processor is configured to cause the first network equipment to:
receive, from a second network equipment, a subscription request for poisoning detection for the one or more third artificial intelligence models; and
transmit, to the second network equipment, a poisoning detection result comprising the model poisoning score.

13. The first network equipment of claim 12, wherein the at least one processor is configured to cause the first network equipment to:
receive, from the second network equipment, one or more identifiers for one or more third network equipment that participated in training the one or more third artificial intelligence models; and
assign the model poisoning score to at least one of the one or more third network equipment.

14. A second network equipment for wireless communication, comprising:
at least one memory; and
at least one processor coupled with the at least one memory and configured to cause the second network equipment to:
transmit, to a first network equipment, a subscription request for poisoning detection for one or more third artificial intelligence models; and
receive, from the first network equipment, a poisoning detection result comprising a model poisoning score indicating a likelihood that at least one of the one or more third artificial intelligence models is in a poisoned state.

15. The second network equipment of claim 14, wherein the poisoning detection result comprises an indication that at least one of the one or more third artificial intelligence models is likely in a poisoned state, and a targeting indication comprising an indication of whether poisoning of the at least one of the one or more third artificial intelligence models is targeted to at least one class of one or more classes of artificial intelligence models.

16. The second network equipment of claim 14, wherein the at least one processor is configured to cause the second network equipment to transmit, to the first network equipment, one or more identifiers for one or more third network equipment that participated in training of the one or more second artificial intelligence models, wherein the poisoning detection result is associated with at least one of the one or more third network equipment.

17. The second network equipment of claim 14, wherein the at least one processor is configured to cause the second network equipment to:
select one or more candidate artificial intelligence models from the one or more third artificial intelligence models based at least in part on the poisoning detection result indicating that the one or more candidate artificial intelligence models are likely not in a poisoned state; and
utilize the one or more candidate artificial intelligence models for one or more of model training or data inference.

18. The second network equipment of claim 14, wherein the at least one processor is configured to cause the second network equipment to:
determine, based at least in part on the poisoning detection result, that the one or more third artificial intelligence models are likely in a poisoned state;
discard the one or more second artificial intelligence models; and
exclude one or more poisoned clients associated with the one or more third artificial intelligence models likely in a poisoned state from taking part in one or more next rounds of federated learning model training.

19. A method performed by a first network equipment, the method comprising:
generating a first distance value based at least in part on a comparison of one or more first artificial intelligence models and one or more second artificial intelligence models;
comparing the first distance value to a distance value threshold;
generating a flag to initiate poisoning score detection based at least in part on whether the first distance value surpasses the distance value threshold; and
generating one or more model poisoning scores based at least in part on comparison of the first artificial intelligence model and one or more third artificial intelligent models in training.

20. A method performed by a second network equipment, the method comprising:
transmitting, to a first network equipment, a subscription request for poisoning detection for one or more third artificial intelligence models; and
receiving, from the first network equipment, a poisoning detection result comprising a model poisoning score indicating a likelihood that at least one of the one or more third artificial intelligence models is in a poisoned state.
